(19) United States
(12) Patent Application Publication
(10) Pub. No.: US 2006/0126324 A1
(43) Pub. Date: Jun. 15, 2006

(54) Illuminator with periscopic optical guidance

(76) Inventors: Fulvio Bresciani, Aramengo (IT); Tiziana Cardile, Torino (IT)

Correspondence Address: MCGLEW & TUTTLE, PC, P.O. BOX 9227, SCARBOROUGH STATION, SCARBOROUGH, NY, 10510-9227, US

(21) Appl. No.: 10/536,478

(22) PCT Filed: Dec. 9, 2003
(86) PCT No.: PCT/IB03/05375

§ 371 Date: May 24, 2005

(30) Foreign Application Priority Data
Dec. 11, 2002 (IT) TO2002A001077

(51) Int. Cl. F21V 9/00

(52) U.S. Cl. 362/153.1; 362/231

(57) ABSTRACT

Periscopic lighting system comprising at least one light source placed in the lower part of the system and at least two optical functions that form as a whole an optical guidance coupled to the source.

This invention refers to a lighting system able to illuminate any kind of zone, part of area or things.

Traditional lighting systems, especially those used for illuminating big areas such as roads, squares, parks, gardens, etc., are characterised by the fact that all the illuminating body is placed at a certain height from the ground, and supported by a standard, generally metallic, which can also reach 12-15 meters in height (motorway exits and squares).

The reason for having such a high supporting standard derives from the fact that, if the light on the ground arrives from points that are lower as to the area to be illuminated, in the areas distant from where the illuminator is placed, the beam of light would fall to the ground with such a small angle that, also with very powerful light sources, the lighting would not be sufficient.

Such traditional lighting systems have manifold drawbacks.

They are partially related to ordinary maintenance, since each time it is necessary to intervene on the light source for replacing it, if it is not working any more, or also only for repairing the power supply and switching-on system of the light, in case of failure, special trucks must be used given the height of the structure. These trucks are equipped with an elevator turret through which the technicians can reach the equipment and carry out the intervention.

All this implies different problems such as very heavy intervention costs, problems on the road traffic if the lighting systems concern roads, squares or road junctions, and intervention difficulties if the supports of the illuminators are located in areas that are difficult to access such as wooded regions or uneven roads. Further drawbacks are also related to the structure and to the wiring harnesses. In the first case, since the projector as a whole (lamp, switching-on ballast, reflector, casing) is quite heavy, the used standard must have certain characteristics of resistance and sturdiness hence the relative sizes and costs are considerable. In the second case, the electric cables powering the illuminating body must be wired, and must run along the inside of the standard with subsequent high costs of installation and of electrical material used.

The aim of this invention is the realisation of a lighting system that shall be practical, reliable, efficient, convenient and without the drawbacks of the known systems indicated above.

The above-mentioned aim is attained by this invention in that it is related to a lighting system particularly suitable for illuminating big areas in open zones but whose operating principle can also be applied for illuminating small areas, such as writing-desks or flat rooms, whose light source with its switching-on system (if necessary, when using discharge lamps) is located in an area of the lighting system that is not placed any more on the peak of the pole or near the peak, but in areas of the structure easily reachable by the operators without special devices such as ladders or elevator turrets, and where the light, through a periscopic optical guidance, is taken to the peak of the structure of the illuminator and then directed on the areas by making full use of the advantages deriving from the height for an efficient lighting by completely eliminating all the above-mentioned drawbacks.

This invention will become more apparent from the following preferred form of execution, supplied by way of non limiting example, and with reference to the annexed drawings wherein:

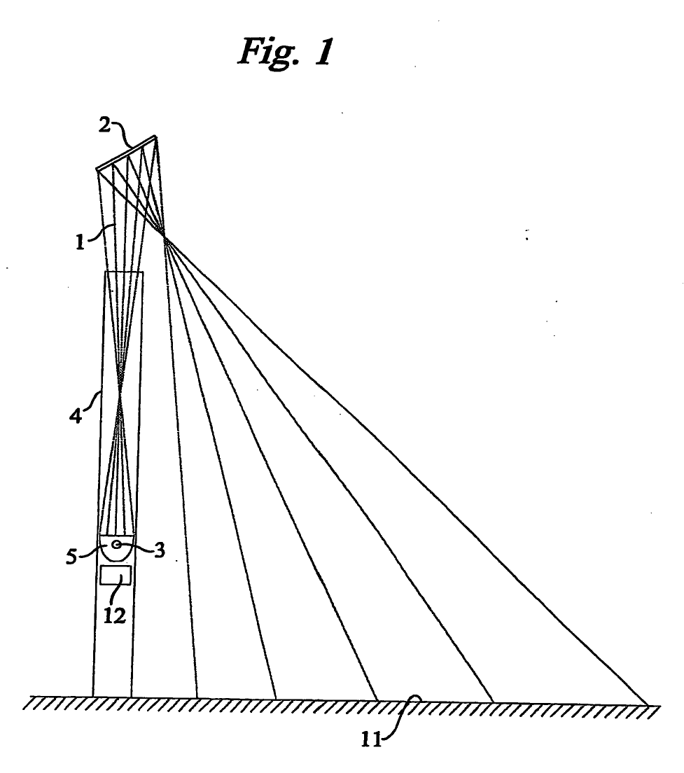

FIG. 1 shows a schematic view of a system usable for lighting a road, for example;

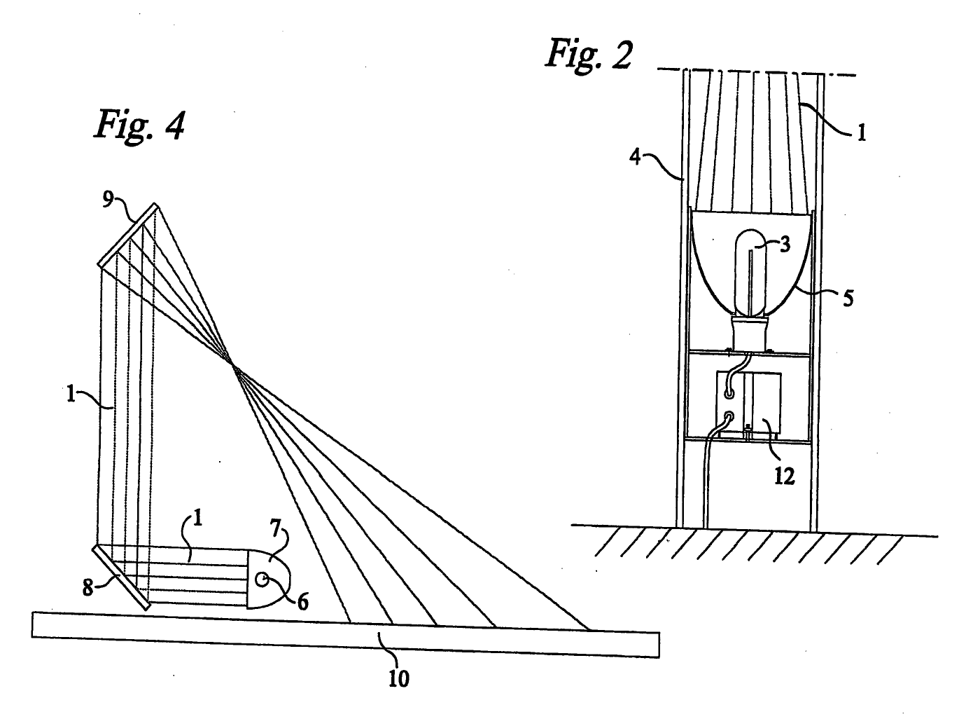

FIG. 2 shows a section of the first optical function of light transfer included in a road lighting system according to the diagram of FIG. 1;

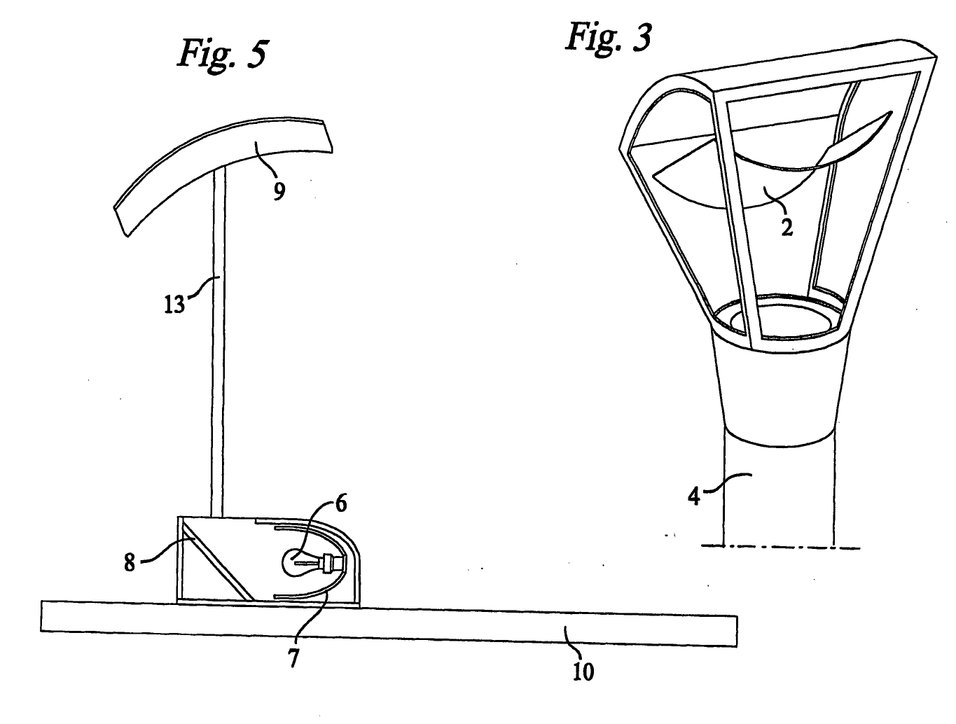

FIG. 3 shows a perspective of the last optical function of light transfer included in a system according to the diagram of FIG. 1;

FIG. 4 shows a schematic view of a table lamp according to the invention;

FIG. 5 shows the section of a table lamp according to the invention;

With reference to FIG. 1-2-3, a lighting system realised according to this invention for illuminating, for example, a roadway, shall now be described.

This lighting system mainly comprises a periscopic optical guidance 1. The optical guidance includes at least two optical functions of “light transfer”, and its aim is to transfer the light from a light source 3, such as a lamp provided with a lighter 12, placed at the base of a tubular standard 4, till the upper end of this standard 4, from where the last function of “light transfer” 2, thanks to its own especially calculated material and shape characteristics, distributes it properly on the part of the roadway 11 to be illuminated.

The optical functions of “light transfer”, which form as a whole the so-called periscopic guidance, may vary in number, shape and type, and this depends on the length and type of path that the light must follow to reach the opposite end of the optical guidance from the light source. The optical functions of “light transfer” are physical elements or devices with their own size and shape, suitable for transferring light through the air along straight pathways, and that work optically according to specific requirements, by reflection (reflectors, mirrors, diffusers) or by transmission (lenses, prisms and optical fibres). The optical functions of “light transfer” must be executed properly in such a way that the light along the path in the air be dispersed as little as possible or be dispersed in a controlled way such as to guarantee a light efficiency meeting the requirements of the lighting system.

The optical function of “light transfer” that receives the light directly from the light source and that is defined as the first optical function of “light transfer” in the chain of functions (indicated by 5 in FIG. 1, and by 7 in FIG. 5), must intercept the most luminous flux possible issued by the source in order to be able to transfer in turn along the periscopic optical guidance according to the methods deriving from the specific final lighting requirements to be obtained.

The optical function of “light transfer” that receives the light from a previous optical function and distributes it directly on the part of surface to be illuminated is defined as the last optical function of “light transfer” (indicated by 2 in FIG. 1, and by 9 in FIG. 4) and it is properly calculated in such a way as to meet the illumination requirements.

The periscopic optical guidance must consist of at least two functions of “light transfer” in order to be able to work as such, which can be increased in a desired number according to the path, efficiency and light distribution deriving from the lighting system requirements.

An example of this invention, in the non-limiting case in point represented here, where the periscopic optical guidance consists of more than two functions of “light transfer”, is given by the application of lighting systems for interiors such as table lamps FIGS. 4 and 5.

In this application the lighting body 6 is at the base of the lamp. The first function of “light transfer”, represented here by a reflector 7, intercepts the luminous flux of the lamp and transfers it to the second function of “light transfer” 8, in this case a flat reflector integral with the base of the lamp and whose aim is to transfer the light on the last function of “light transfer” 9 located on top of the stand 13 of the lamp, in this case a reflector having a properly calculated shape, whose aim is to transfer the light by reflection on the part of the area of the writing-desk or other surface 10 on which the lamp rests.

The advantages are clear in this application of the invention.

The terminal of the lamp on top of the stand 13, from where the light is distributed on the surface to be illuminated, is very light and has a low temperature since it has no light source and relative accessories such as lamp holder, cables, etc. with ensuing manoeuvrability.

Generally, the optical guidance 1 when applied in external lighting, can be incorporated within the standard (lamppost) 4 of the lighting system, in order to protect the components from external agents and to prevent matt bodies from interfering along the light path through the guidance by interrupting the transfer and compromising the operation of the system itself.

If the present invention has the optical guide totally or even only partially incorporated within the standard, apart from illuminating it may also signal.

If the standard of the lighting system is made of a transparent film able, on the one hand, to partially transfer the falling light, and to diffuse it, on the other hand, the standard shall be illuminated and hence visible from the outside.

This invention allows to obtain this effect since not all the light running along the periscopic optical guidance reaches the last function of “light transfer”, but partially, along the pathways in the air, it is dispersed sideways by falling on the transparent film that forms, either totally or only partially, the standard of the lighting system, exiting later in the external environment.

This application of this invention is useful, for example, in road lighting systems, where in case of fog or poor visibility, the lighting systems placed as traditional lampposts along the side of the roads or in the middle of the junctions form a sort of luminous guidance that curls along all the path of the road on which they are installed.

1. Periscopic lighting system comprising at least one light source placed in the lower part of the system and at least two optical functions that form as a whole an optical guidance coupled to the source.

2. Lighting system according to claim 1, comprising one or more light sources fit for generating light radiations in the frequency spectrum of the visible region and/or in the ultraviolet and/or infrared region.

3. Lighting system according to claim 1, characterized by two or more functions of “light transfer” of the following type: reflector, mirror, diffuser, lens, prism or optical fibre.

4. Lighting system according to claim 3, characterized in that the shape of at least one of the “light transfer” functions is calculated in such a way as to deviate or transmit light as well as to distribute it, according to preset methods, on the region or area to be illuminated.

5. System according to claim 1 in which the optical functions forming as a whole the optical guidance that directs the light from the irradiating source to the part of the area external to the lighting system on which the radiation falls, are such that the light that falls on one of them can completely or even only partially be deviated on another optical function of the guidance or on the area or region to be illuminated.

6. System according to claim 1 in which the optical guidance that transmits the light from the light source to the last function of “light transfer” after which the light falls on the surface to be illuminated, is incorporated or partially incorporated or not incorporated in the structure of the lighting system.

7. Lighting system according to claim 6, in which the optical guidance is incorporated or partially incorporated in a holding structure and the holding structure has a surface treatment that modifies the characteristics of reflection of the material of which it is made or only on the internal surface or only on the external surface or on both surfaces.

8. Lighting system according to claim 7, in which the holding structure is realized with special materials such as specific transmitting and diffusing films already used in signaling systems for road applications and more.

9. Lighting system according to claim 7, in which the holding structure consists of special materials such as specific transmitting and diffusing films, the system is fit for illuminating and sing signaling by using the light that is dispersed along the path of the periscopic optical guidance and that by falling on the said materials of the structure it streams out and is dispersed in the environment.

10. Lighting system according to claim 1, in which the source is mounted inside an optical guidance.

11. Lighting system according to claim 10, in which a (first) reflector is associated to the source, this reflector acts as the first optical function in the sense indicated above.

12. Lighting system according to claim 6, in particular for illuminating roads and alike, comprising a tubular standard, whose lower part houses the source in such a way that the latter is accessible/replaceable from the ground; since the said optical guidance is realized at least partially in the said standard.

13. Lighting system according to claim 12, in which at the peak of the said standard a (second) reflector is connected. This reflector is fit for deviating downwards, out of the said pole, the radiation coming from the said source.

14. Lighting system according to claim 11, in which for the utilization as a table lamp or alike, the source and the (first) associated reflector are placed in a hollow supporting base, having an upper window turned upwards for the exit of the beam that, generated from the source, is deviated from the said (first) reflector.

15. Lighting system according to claim 14, in which a standard is connected to the supporting base, this standard stretches upwards and carries a second reflector fit for deviating downwards the radiation streaming out from the said window of the base.
